(19) United States
(12) Patent Application Publication
(10) Pub. No.: US 2006/0065719 A1
(43) Pub. Date: Mar. 30, 2006

(54) Method of associating a non-proprietary card with a profile

(76) Inventor: Brian J. Doyle, Victoria (CA)

Correspondence Address: THOMPSON LAMBERT;SUITE 703D, CRYSTAL PARK TWO, 2121 CRYSTAL DRIVE, ARLINGTON, VA, 22202, US

(21) Appl. No.: 10/950,537

(22) Filed: Sep. 28, 2004

(51) Int. Cl. G06K 5/00

(52) U.S. Cl. 235/382

(57) ABSTRACT

A method of using an existing card to access a profile, the method comprising the steps of capturing identification information such as magnetically readable information on a card such as a magnetically readable card issued by a card issuer and carried by a card holder, associating the identification information on each card with a profile without authority of the card issuer, and accessing the profile using the identification information of the card. The profile may comprise a financial balance, membership information such as a membership profile, customer loyalty benefits, membership benefits, and/or access to discounts. Accessing the profile may comprise debiting or crediting the financial balance. The information may be associated with a profile in a server and the profile may be accessed from a remote location. The remote location may be a point of sale reader which may use a wireless connection to connect to the server, an internet connection, and/or a telephone connection.

### BACKGROUND OF THE INVENTION

It is customary for consumers to have many different types of magnetically readable cards, such as membership cards, debit cards, credit cards, discount cards, prepaid cards, etc. Each business or organization that uses a card has an interest in having their own card issued for advertising purposes as well as obtaining demographic information about their customers. However, there is a growing sentiment that there are too many cards being issued, which causes undue waste, and there are people who wish to keep personal information private. In addition, some small businesses who could benefit from the convenience of a card cannot afford to issue one. This invention relates to a method of using existing cards to address these issues.

### SUMMARY OF THE INVENTION

There is therefore provided, according to an aspect of the invention, a method of using an existing card to access a profile, the method comprising the steps of capturing identification information such as magnetically readable information on a card such as a magnetically readable card issued by a card issuer and carried by a card holder, associating the identification information on each card with a profile without authority of the card issuer, and accessing the profile using the identification information of the card. The profile may comprise a financial balance, membership information such as a membership profile, customer loyalty benefits, membership benefits, and/or access to discounts. Accessing the profile may comprise debiting or crediting the financial balance. The information may be associated with a profile in a server and the profile may be accessed from a remote location. The remote location may be a point of sale reader which may use a wireless connection to connect to the server, an internet connection, and/or a telephone connection.

According to another aspect of the invention, there is provided a method of using a card to perform transactions, the method comprising the steps of capturing identifying information such as magnetically readable information on a card such as a magnetically readable card issued by a card issuer, the identifying information being associated with a first set of functions defined by the card issuer; associating the identifying information with a second set of functions distinct from the first set of functions; and using the identifying information to perform a function in the second set of functions. The second set of functions may comprise debiting or crediting a financial balance, providing access to restricted services or areas such as a public transit service, and storing and updating membership information, such as a membership profile, customer loyalty benefits, membership benefits, and/or access to discounts. The identifying information may be associated with the second set of functions in a server and the second set of functions may be accessed from a remote location, such as a point of sale reader which may use a wireless connection to connect to the server, an internet connection, and/or a telephone connection.

According to a further aspect of the invention there is provided profiles for use in the above.

Other aspect of the invention will become apparent from the claims, which are associated herein by reference.

### BRIEF DESCRIPTION OF THE DRAWINGS

There will now be given a brief description of preferred embodiments of the invention, with reference to the drawings, by way of illustration only and not limiting the scope of the invention, in which like numerals refer to like elements, and in which:

FIG. 1 is a flow chart representing the steps of an embodiment of the invention;

FIG. 2 is a block diagram of the hardware used in an embodiment of the invention;

FIG. 3 is an example of the bit sequence of a transaction.

### DETAILED DESCRIPTION OF THE DRAWINGS

In this patent application, and in the claims, the term card refers generally to cards with a unique signature, such as a number to identify that card, but also refers to any type of electronic card now known or created in the future having the same function as currently used credit, security or identification cards. The electronic card may be a thin plastic card with an electronically readable strip such as a magnetically readable strip, or may be an electronic chip of any configuration either as a stand alone unit or associated with, such as by embedding in, some other medium. Exemplary electronic cards include a credit card issued by a bank with a magnetically readable strip on the back, or a magnetically readable student identification card issued by an educational institution. It will be recognized that other types of devices carrying unique signatures may be designed in the future. While the description herein will use a card with a magnetically readable strip on the back and the number printed on the front as the preferred embodiment, a person skilled in the art will recognize that the teachings may be adapted to other situations.

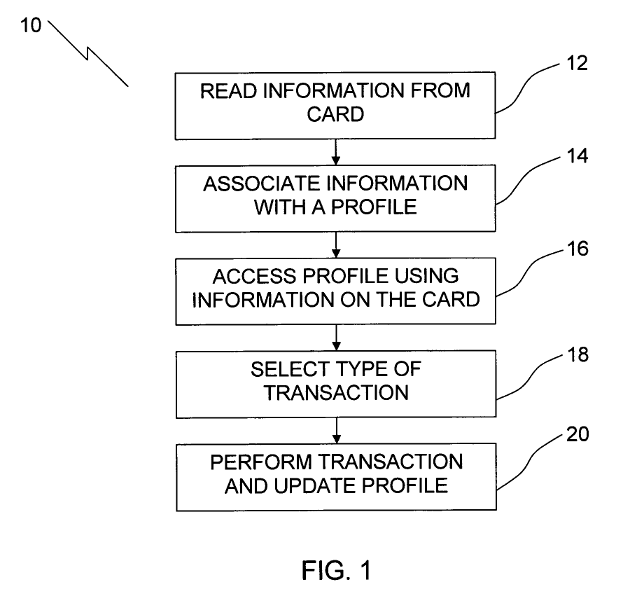

Referring to FIG. 1, the method 10 begins by reading the information on a card 12 that is issued by a card issuer and carried by a card holder. The information may be obtained by, for example, swiping a card through a card reader, or by entering the information manually. This information is recorded and associated with a profile 14 by an entity that is not the card issuer. While the card issuer intended the information on the card to allow the holder to perform a first set of functions, the teachings presented herein allow the information to be stored elsewhere and the card can then allow the user to perform a second, distinct set of functions. The information and profile are preferably stored on a remote server, accessible through a network. Since the card number is unique, there is no need to record any further personal information, the type of card or the card issuer. This information would only be gathered if required for specific purposes, for example, if the card information were to be associated with a membership profile. Once the profile is associated with the number, the holder of the card may then access the profile and the assets associated with the profile using the information on the card 16, and select a type of transaction 18. The transaction is performed and the profile is updated 20. In some situations, the transaction may be selected by default such as at a point of sale device, where debiting a financial balance may be the default transaction. Other transactions may include depositing money to create a financial balance in the profile such that the card may be used as a stored value card. There are different ways of doing this. For example, money may be deposited as cash with a machine such as a bill acceptor connected to the server, over the internet, by telephone, or with a merchant as a point of sale. When practical, cash may used to create the financial balance, or money may also be moved using a credit or debit card, or other means commonly used to transfer money. Software packages that make these transactions possible are well known in the art. To use the stored value, the user swipes the card at a point of sale and the transaction amount would be credited from the profile. Preferably, the transactions would not be for large sums of money, with limits applied if required. Once the balance reached a certain level, the user may be warned that the funds are nearly depleted, in which case money may be applied to the profile. This may be useful for paid parking, pay phones, public transit, toll booths, car washes, or stores where small purchases are made, such as coffee shops, fast food restaurants, or grocery stores. In addition to its use as a stored value card, the profile may also contain information relating to things such as customer loyalty, for example where the tenth coffee is free, or receiving discounts, such as a membership card. This may appeal to independent merchants as a means of replacing temporary cards such as those initialed or punched with each purchase. The cost to the merchant could be quite reasonable, it would reduce the instances of fraud, and the customers would have fewer items to clutter their pockets or wallets. This system may also be used by larger institutions may provide their patrons with the option of opting out of receiving the traditional membership card and using an existing card instead by associating the membership with the number through the profile. Another option is to use the profile to provide access to restricted services or areas. For example, the card that is used could act as a pass to transit services with magnetic readers.

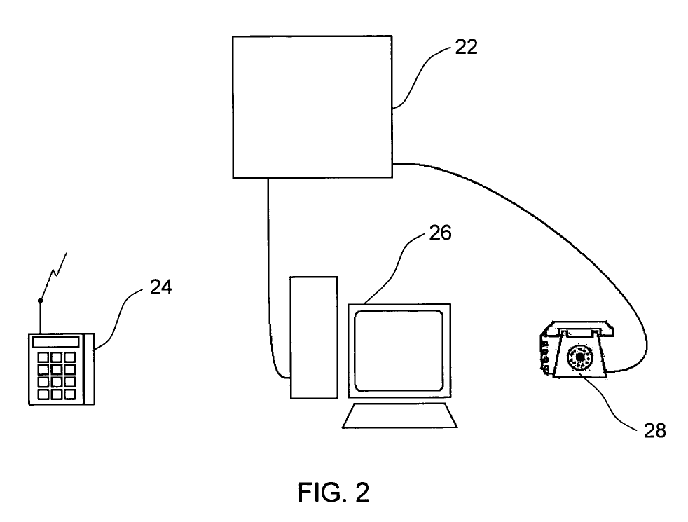

As mentioned above, and referring to FIG. 2, the server 22 storing the profile may be accessed from remote locations such as by using a point of sale reader 24, an internet connection 26 by going to a web page designed for that purpose, or a telephone connection 28 by calling a designated phone number. The services available may include checking the balance, transferring funds, or replacing the number associated with the profile to another number, for example, if the magnetic strip on the back became unreadable, or if the card had been lost or stolen and a record of the number was kept. It would likely be necessary to password protect the information to prevent unauthorized access to the balance, which could be done at the time the profile was associated.

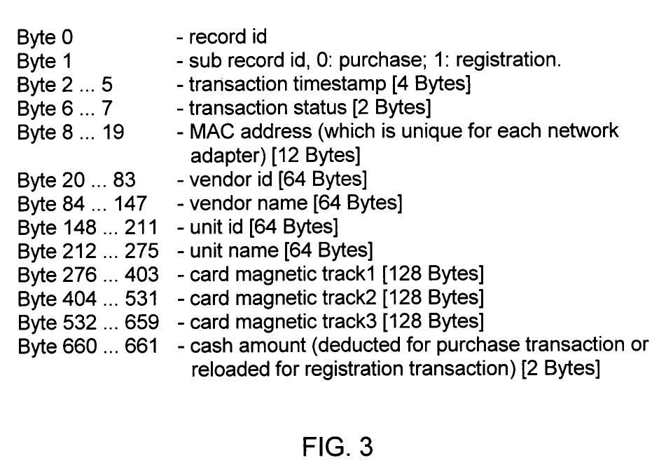

To properly manage the profiles and connect with the various remote locations where the profile may be accessed, a software system may be used. An example of a bit structure of a profile that may be used is shown in FIG. 3. This structure may be modified depending upon the situations required. The costs associated with implementing a card-based program are reduced significantly as there are no cards to be purchased, and no costs associated with distributing and maintaining distribution lists and card services departments. Because the operating costs are low, it is possible to charge less per transaction, making it more attractive to merchants. Depending upon the situation, the method may require the distribution of some point of sale devices 22. These devices 22 may be wireless as shown in FIG. 3 for situations where there isn't already an internet connection, and can operate on unlicensed and free bandwidth such as 8021 μl or Wi-Max which are becoming increasingly popular. In other situations, the business or organization that is using the system may find it more practical to license the software for their own server instead of connecting to a central server. For example, a large institution that already has a server with membership information may find it less complicated to integrate the teachings of this invention with their own server in order to keep the information centralized.

Immaterial modifications may be made to the embodiments described in this disclosure without departing from the invention.

1. A method of using an existing card to access a profile, the method comprising the steps of:
capturing identification information on a card issued by a card issuer and carried by a card holder;
associating the identification information on each card with a profile without authority of the card issuer, in which the profile includes a financial balance; and
accessing the profile using the identification information of the card and crediting the financial balance with a cash transaction.

2. The method of claim 1 wherein the card is an electronically readable card, and the identifying information is electronically readable information.

3. (canceled)

4. (canceled)

5. The method of claim 1 wherein the profile comprises membership information.

6. The method of claim 5 wherein membership information comprises information selected from a group consisting of a membership profile, customer loyalty benefits, membership benefits, and access to discounts.

7. The method of claim 1 wherein the information is associated with a profile in a server and the profile is accessed from a remote location.

8. The method of claim 7 wherein the remote location is a point of sale reader.

9. The method of claim 8 wherein the point of sale reader uses a wireless connection to connect to the server.

10. The method of claim 7 wherein the remote location is an internet connection.

11. The method of claim 7 wherein the remote location is a telephone connection.

12-40. (canceled)

41. The method of claim 1 further comprising the step of subsequently accessing the profile to debit the financial balance with a cash transaction.
